(19) United States
(12) Patent Application Publication
(10) Pub. No.: US 2026/0199778 A1
(43) Pub. Date: Jul. 16, 2026

(54) VEHICLE CONTROL DEVICE AND VEHICLE CONTROL METHOD

(71) Applicant: TOYOTA JIDOSHA KABUSHIKI KAISHA, Toyota-shi (JP)

(72) Inventor: Takashi SAITO, Fuji-shi (JP)

(73) Assignee: TOYOTA JIDOSHA KABUSHIKI KAISHA, Toyota-shi (JP)

(21) Appl. No.: 19/391,450

(22) Filed: Nov. 17, 2025

(30) Foreign Application Priority Data
Jan. 14, 2025 (JP) 2025-004796

(51) Int. Cl. A63F 13/285; A63F 13/803; B60R 16/03; A63F 13/215; A63F 13/245

(52) U.S. Cl. CPC A63F 13/285; A63F 13/803; B60R 16/03; A63F 13/215; A63F 13/245

(57) ABSTRACT

A vehicle control device comprises: an acquirer that acquirers play information of a game played by an occupant of a vehicle; and a controller that controls a vehicle behavior control device capable of oscillating a vehicle body according to the acquired play information. The controller controls in either a limited game mode, which limits the amount of power that can be consumed for driving the vehicle behavior control device, or in a normal game mode, which has a larger amount of power consumption than the limited game mode, when the controller controls the vehicle behavior control device according to the play information.

### REFERENCE TO RELATED APPLICATIONS

This application is based upon and claims the benefit of priority from the prior Japanese Patent Application No. 2025-004796 filed on Jan. 14, 2025, the entire contents of which are incorporated herein by reference. The entire contents of which are incorporated herein by reference.

### BACKGROUND

### Technical Field

This disclosure relates to technology for controlling a vehicle behavior control device that shakes the vehicle body while the vehicle is stopped.

### Background Information

JP 2021-113046 discloses an active suspension system between a vehicle wheel and a vehicle body in series or parallel with an air suspension system. The active suspension system is used to induce certain motions in the vehicle when playing video games. These motions are induced in response to pre-recorded motion tracking associated with audio or video recordings, or in response to commands given by the video game player in the car using controller inputs.

In the technology disclosed in JP 2021-113046, the active suspension is driven to induce a specific motion in the vehicle, but the power consumption of the power supply device feeding the active suspension may become large.

### SUMMARY

The purpose of the present disclosure is to provide a technology that can reduce power consumption when a vehicle behavior control device shakes the vehicle body in response to game play in the vehicle.

A vehicle control device according to one embodiment comprises: an acquirer that acquirers play information of a game played by an occupant of a vehicle; and a controller that controls a vehicle behavior control device capable of oscillating a vehicle body according to the acquired play information. The controller controls in either a limited game mode, which limits the amount of power that can be consumed for driving the vehicle behavior control device, or in a normal game mode, which has a larger amount of power consumption than the limited game mode, when the controller controls the vehicle behavior control device according to the play information.

Another embodiment is a vehicle control method comprising: acquiring play information of a game played by an occupant of the vehicle; and controlling a vehicle behavior control device capable of oscillating a vehicle body according to the acquired play information. In the controlling, when controlling the vehicle behavior control device according to the play information, the vehicle behavior control device is controlled in either a limited game mode, which limits the amount of power that can be consumed for driving the vehicle behavior control device, or a normal game mode, which has a larger amount of power consumption than the limited game mode.

### BRIEF DESCRIPTION OF THE DRAWINGS

FIG. 1 shows the functional configuration of the example vehicle control system.

FIG. 2 is a diagram of a vehicle equipped with an active stabilizer system and an active suspension system.

FIG. 3 illustrates the normal and limited game modes that define the amount of power that can be consumed.

FIG. 4 illustrates the control of the vehicle behavior controller when the power supply is charging.

FIG. 5 illustrates a variant of the limited game mode.

### DETAILED DESCRIPTION

The invention will now be described by reference to the preferred embodiments. This does not intend to limit the scope of the present invention, but to exemplify the invention.

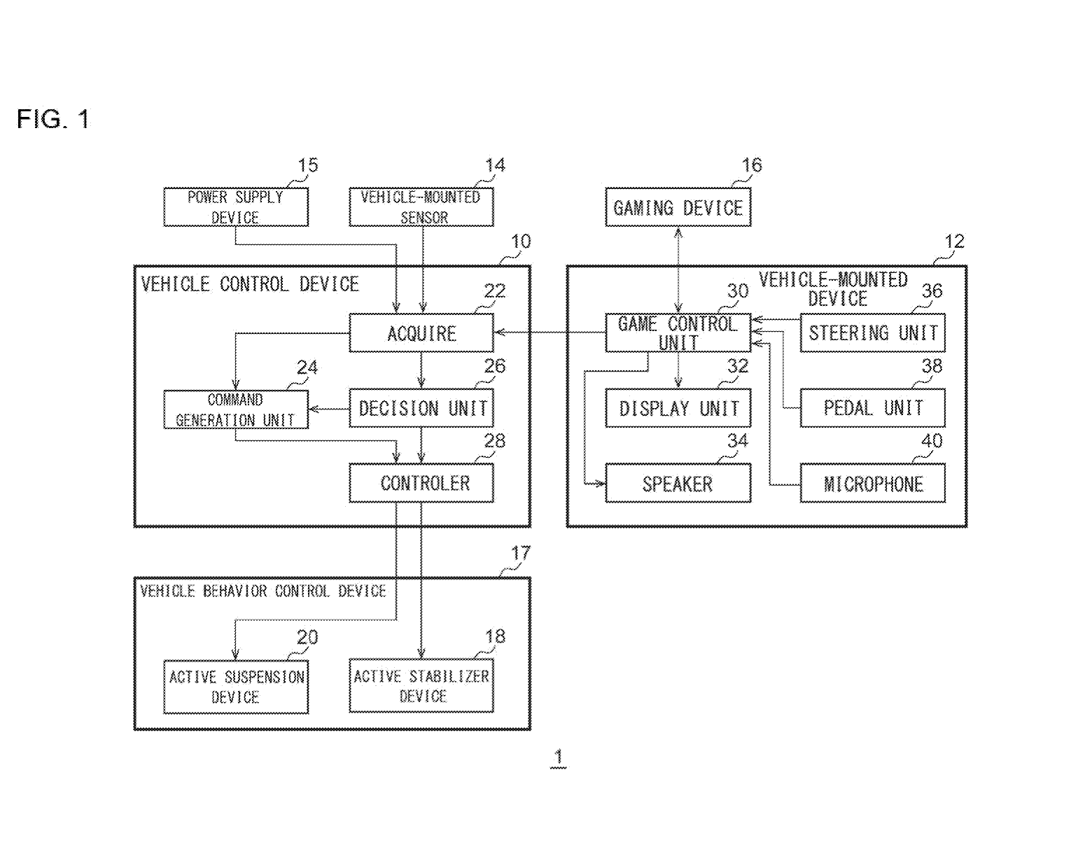

FIG. 1 shows the functional structure of the example vehicle control system 1. In FIG. 1, each element described as a functional block that performs various processes can be composed of circuit blocks, memory, and other LSIs in terms of hardware, and in terms of software, they are realized by programs loaded into memory, etc. Therefore, it is understood by those skilled in the art that these functional blocks can be realized in various ways by hardware alone, software alone, or a combination thereof, and are not limited to any of them.

The vehicle control system 1 includes a vehicle control device 10, an vehicle-mounted device 12, an vehicle-mounted sensor 14, a power supply device 15, a gaming device 16, and a vehicle behavior controller 17. The vehicle control system 1 may be installed in a vehicle having an automatic driving function that can drive autonomously. The vehicle equipped with the vehicle control system 1 may be a PHEV (Plug-in Hybrid Electric Vehicle), BEV (Battery Electric Vehicle), HEV (Hybrid Electric Vehicle), or FCEV (Fuel Cell Electric Vehicle (FCEV).

The vehicle control system 1 allows occupants to play games in the vehicle using the in-vehicle device 12. While the occupants are playing the game, the vehicle is stationary. The vehicle control system 10 controls the vehicle behavior controller 17 to execute a control to shake the vehicle according to the game playing state. This can bring a sense of realism of the game to the occupants. The vehicle behavior control device 17 has an active stabilizer device 18 and an active suspension device 20, which can rock the vehicle body.

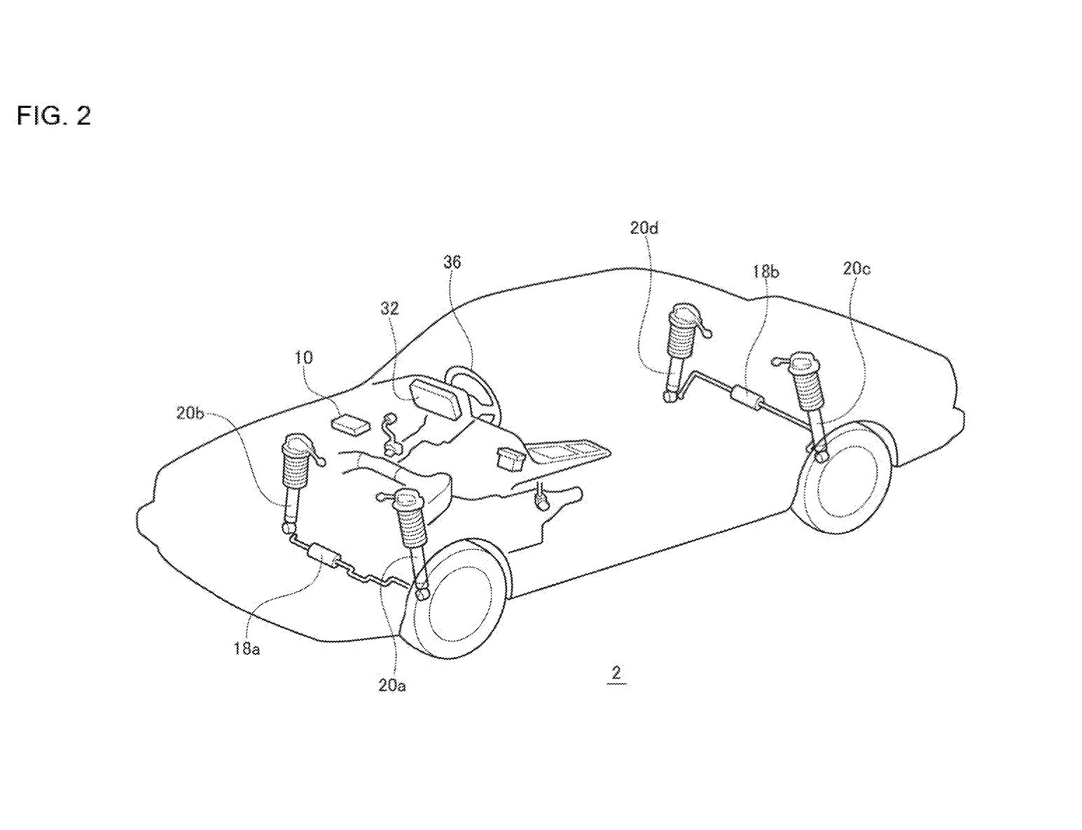

FIG. 2 shows a diagram of a vehicle 2 equipped with an active stabilizer device 18 and an active suspension device 20. The active suspension device 20 is positioned between the wheels and the vehicle body and generates damping force for inputs from the wheels and the vehicle body. The active suspension device 20 consists of a first active suspension device 20a located on the left front wheel, a second active suspension device 20b located on the right front wheel, a third active suspension device 20c located on the left rear wheel, a fourth active suspension device located on the right rear wheel 20d.

The active suspension device 20 may be an air suspension device or a electric or hydraulic full active suspension device. In either case, the active suspension device 20 can oscillate the vehicle body in the roll and vertical directions. The active suspension devices 20 on the left and right wheels can oscillate the vehicle body in the vertical direction when the active suspension devices 20 on the left and right wheels are driven simultaneously on both sides, and the active suspension devices 20 on the left and right wheels can oscillate the vehicle body in the roll direction when they are driven at different times.

The active stabilizer device 18 has a first active stabilizer device 18a located on the front wheel side and a second active stabilizer device 18b located on the rear wheel side. The active stabilizer devices 18 are connected at both ends to the left and right wheels, e.g., lower arms. The active stabilizer device 18 may be provided only on the front wheel side.

The active stabilizer device 18 has a right stabilizer bar, a left stabilizer bar, and an electric actuator that connects the right and left stabilizer bars for relative rotation. The vehicle control device 10 can drive the electric actuator to rotate the right stabilizer bar and the left stabilizer bar relative to each other to apply roll direction force to the vehicle body. The active stabilizer system 18 is used to control the roll direction movement of the vehicle body, but in the example, it is used to sway the vehicle body in the roll direction.

Return to FIG. 1. The vehicle-mounted sensors 14 include sensors that detect the amount of drive of the active stabilizer device 18, sensors that detect the amount of drive of the active suspension device 20, and sensors that detect the stopping of the vehicle. The in-vehicle sensors 14 send the detection results to the vehicle control device 10 using in-vehicle communications.

The power supply device 15 supplies power to the active stabilizer device 18 and the active suspension device 20. The power supply device 15 sends information indicating the charging rate of the power supply device 15 to the vehicle control device 10, and if the power supply device 15 is being charged from an external source, information indicating that it is being charged is sent to the vehicle control device 10.

The gaming device 16 is an external device that is brought into the vehicle 2 but is not pre-installed in the vehicle 2, and includes AR glasses, VR headsets, external displays, game controllers, speakers and vibration devices. The gaming device 16 is connected to the in-vehicle device 12 and sends and receives information about the game. The gaming device 16 may include a game console body and send and receive information to and from the vehicle control device 10. The game console itself may be a smartphone. The game device 16 connects to the in-vehicle device 12 wirelessly or wired.

The in-vehicle device 12 has a game control unit 30, a display unit 32, a speaker 34, a steering unit 36, a pedal unit 38, and a microphone 40. The display 32 may be, for example, a display in a center console, a display in a passenger seat or rear seat, or an instrument panel, or a combination thereof. Display 32 and speaker 34 function as game output devices and output images and sounds received from game control unit 30. The game output device may further include at least one of the following: an air conditioning device, a seat vibration device, and a haptic pedal. The active stabilizer device 18 and the active suspension device 20 are also game output devices.

Steering device 36, pedal device 38 and microphone 40 serve as game input devices. The steering device 36 sends the rudder angle and rudder angle speed to the game control unit 30. The pedal device 38 sends the accelerator pedal and brake pedal operation amounts to the game control unit 30, respectively. Microphone 40 detects sounds, including the voice of the occupants, and sends them to game control unit 30. The game input devices may be set according to the type of game, e.g., steering device 36 and pedal device 38 are used when running a game in which vehicles are raced.

The game control unit 30 holds a plurality of programs for games, generates play results in response to inputs from the game input devices, and sends them to the game output devices. The game control unit 30 also sends play information indicating that a game is being executed to the vehicle control device 10 using in-vehicle communications. The game control unit 30 can communicate wirelessly with an external game server device and may send input information from the game input device to the server device and receive play results from the server device. The play results include images and sounds.

The play information may include information indicating that a game is being played, information requesting the driving of the vehicle behavior control device 17, and information regarding the amount of driving of the vehicle behavior control device 17. For example, the game control unit 30 requests the driving of the vehicle behavior controller 17 when a racing game or an action game is being played. For example, information regarding the amount of drive of the vehicle behavior controller 17 includes information indicating the movement of the vehicle in the game, including information indicating the vehicle's speed, steering angle, acceleration, and collision.

The vehicle control device 10 has an acquisition unit 22, a command generation unit 24, a decision unit 26, and a controller 28. The acquisition unit 22 acquires play information for games played using the in-vehicle device 12 or games played using the game device 16. The acquisition unit 22 may acquire play information from the game device 16 using short-range wireless communication. In either case, the play information is generated by being executed by an occupant in the vehicle. The acquisition unit 22 acquires detection results from the in-vehicle sensors 14. The acquisition unit 22 acquires information indicating the state of charge of the power supply device 15 that supplies power to the vehicle behavior controller 17. The information indicating the charging state of the power supply device 15 includes the charging rate of the power supply device 15 and information indicating whether the power supply device 15 is charging.

The determining unit 26 determines to drive the vehicle behavior control device 17 based on the play information acquired by the acquiring unit 22. The decision unit 26 determines whether to control the vehicle behavior controller 17 in a normal game mode or in a limited game mode that limits the amount of power that can be consumed.

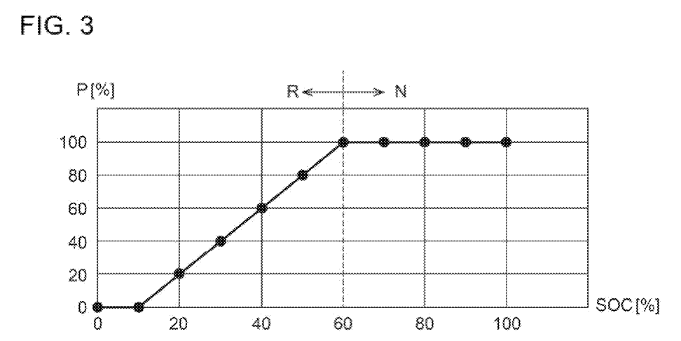

FIG. 3 illustrates the normal game mode and the limited game mode that determine the amount of power that can be consumed. The vertical axis shown in FIG. 3 is the amount of consumable electric power P, and the horizontal axis is the SOC (State Of Charge) of the power supply device 15 that supplies power to the vehicle behavior controller 17, both in percent. The SOC is also referred to as the charge rate, and is information that indicates the state of charge.

If the SOC is 60 percent or higher, the control mode is the normal game mode N, and the amount of power available for consumption, P, is 100 percent. In other words, if the SOC is above the first predetermined value, the vehicle behavior controller 17 is controlled in the normal game mode N where the amount of consumable power P is the largest. This allows the vehicle body to be shaken significantly to bring a sense of realism of the game to the occupants.

If the SOC is less than 60 percent, the control mode is the limited game mode R. As the SOC decreases from 60 percent, the amount of power available for consumption P decreases, and when the SOC reaches 10 percent, the amount of power available for consumption P is zero. In other words, if the SOC is below the second predetermined value, the control of rocking by the vehicle behavior controller 17 during the game is stopped; between the first and second predetermined values of SOC, the amount of consumable power P decreases as the SOC decreases. Thus, by adjusting the amount of consumable power P to the vehicle behavior controller 17 according to the SOC of the power supply device 15, the control of the vehicle behavior controller 17 can be continued while placing restrictions on power consumption. This allows both the charging/discharging performance of the power supply device 15 and the realism of the game to be improved.

Return to FIG. 1. The decision unit 26 sends the decision result to the command generation unit 24 and the control part 28. Based on the play information, the command generation unit 24 generates command values to the active stabilizer device 18 and/or the active suspension device 20 so that the vehicle body is shaken in conjunction with the game play status. For example, if a vehicle racing game is being played, when a vehicle in the game turns, the command generator 24 tilts the actual vehicle body, and when a vehicle in the game is rear-ended, the command generator 24 generates command values to make the actual vehicle body sway back and forth. The command generation unit 24 sends the generated command values to the control section 28.

The controller 28 controls the vehicle behavior controller 17 according to the command values of the command generation unit 24 and the decision results of the decision unit 26. The controller 28 may comprise a plurality of electronic control units (ECU). The ECU may consist of an ECU controlling the first active stabilizer device 18a, an ECU controlling the second active stabilizer device 18b, an ECU controlling the active suspension device 20, etc.

When controlling the vehicle behavior control device 17 according to the play information, the controller 28 controls by either the limited game mode or the normal game mode according to the decision result of the decision unit 26. In the limited game mode, each ECU limits the current value to the vehicle behavior controller 17 to limit the amount of power P that can be consumed. If the voltage value is rated, the amount of power is also limited when the current value is limited.

The control unit 28 controls the vehicle behavior controller 17 in either the limited game mode or the normal game mode based on the information indicating the state of charge obtained by the acquisition unit 22. As a result, the vehicle control device 10 can appropriately control the discharge to the vehicle behavior controller 17 according to the state of charge of the power supply device 15.

The control unit 28 sets the amount of consumable power P based on the charging rate of the power supply device 15 in the limit game mode. This allows the vehicle control device 10 to suppress the loss of remaining energy in the power supply device 15 by supplying power to the vehicle behavior control device 17.

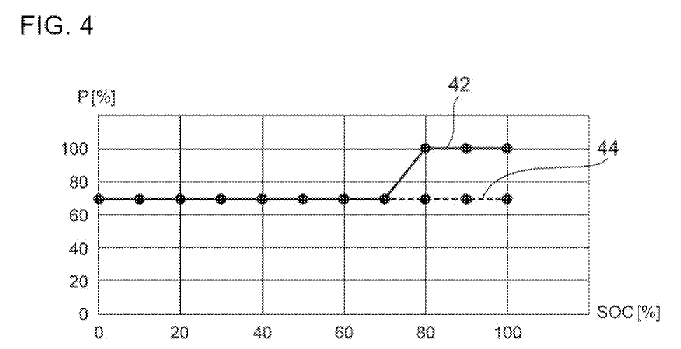

FIG. 4 illustrates the control of the vehicle behavior controller 17 when the power supply 15 is charging. The vertical axis shown in FIG. 4 is the amount of power available for consumption P, and the horizontal axis is the SOC of the power supply 15, both in percent. In the manner shown in FIG. 4, the vehicle equipped with the vehicle control system 1 is a BEV or PHEV.

If the power supply 15 is not charging, the decision unit 26 decides to control the vehicle behavior controller 17 in the normal game mode 42. If the power supply 15 is charging, the decision unit 26 decides to control the vehicle behavior controller 17 in the limited game mode 44.

In the normal game mode 42 and the limited game mode 44, if the SOC is less than 70 percent, the consumable power P is set to 70 percent and is common. On the other hand, when the SOC is above 70 percent, the consumable power P increases in the normal game mode 42, but in the limited game mode 44, the consumable power P does not increase and is maintained at 70 percent. In the normal game mode 42, when the SOC is above 80 percent, the amount of consumable power P is controlled at 100 percent.

In the normal game mode 42, the amount of consumable power P is set to increase when the SOC is above a predetermined value compared to the limited game mode 44. In the limited game mode 44, the controller 28 always controls the amount of power available for consumption smaller than the maximum amount of power available for consumption, regardless of which value the SOC is at.

In the limited game mode 44, the consumable power P is always kept at 70 percent, and when the power supply 15 is being charged, charging is given priority. Even in the limited game mode 44, the amount of consumable power P may be increased if the SOC is higher. In any case, the limited game mode 44 has a smaller amount of consumable power P than the normal game mode 42 when the SOC is within a predetermined range.

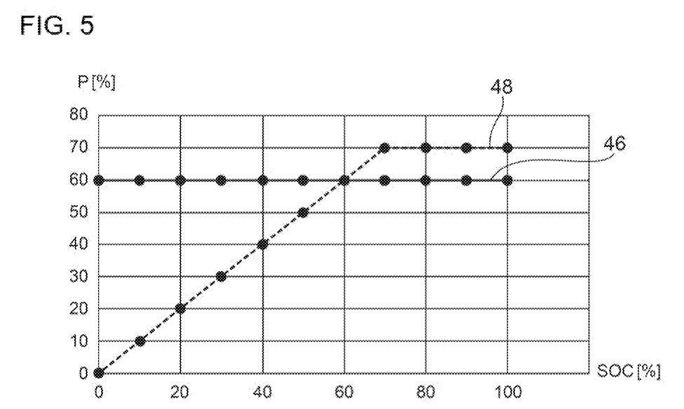

FIG. 5 illustrates the variant limited game mode. The vertical axis shown in FIG. 5 is the amount of consumable power P, and the horizontal axis is the SOC of the power supply device 15, both in percent.

The limit game mode shown in FIG. 5 can be set by input from the occupant. For example, a button called "power saving mode" is provided, and the occupant presses that button to execute the limited game mode. The occupant can set the limited game mode not only by pressing the button, but also by voice input. The in-vehicle sensor 14 detects the occupant's input and transmits it as input information to the acquisition unit 22. The acquisition unit 22 acquires the input information indicating that the game is to be executed in the limited game mode.

The decision unit 26 decides to switch between the normal game mode and the limited game mode based on the input information by the occupant. The controller 28 receives the decision result of the decision unit 26 and controls the vehicle behavior control device 17 in either the normal game mode or the limited game mode based on the input information.

In FIG. 5, two types of limited game modes are illustrated, with a first limited game mode 46 and a second limited game mode 48. In the first limited game mode 46 and the second limited game mode 48, the consumable power P is less than 70 percent regardless of the SOC and is controlled. In the normal game mode, the power consumption P is 100 percent.

In the first limited game mode 46, the amount of consumable power P is set at 60 percent regardless of SOC. In the second limit game mode 48, the amount of consumable power P is set at 70 percent if the SOC is greater than 70 percent, and the amount of consumable power P decreases toward zero as the SOC becomes less than 70 percent. In this way, the occupant can select the power-saving mode when running the game.

The first limited game mode 46 or the second limited game mode 48 shown in FIG. 5 may be set separately from the restricted modes shown in FIGS. 3 and 4. In other words, the restriction mode shown in FIG. 5, which is executed by the occupant pressing a button, is set apart from the restriction mode shown in FIGS. 3 and 4, which is executed according to the state of charge of the power supply 15.

It is understood by those skilled in the art that the examples are only illustrative and that various variations in the combination of each component are possible, and that such variations are also within the scope of the present disclosure invention.

1. A vehicle control device comprising:
an acquirer that acquirers play information of a game played by an occupant of a vehicle; and
a controller that controls a vehicle behavior control device capable of oscillating a vehicle body according to the acquired play information,
wherein the controller controls in either a limited game mode, which limits the amount of power that can be consumed for driving the vehicle behavior control device, or in a normal game mode, which has a larger amount of power consumption than the limited game mode, when the controller controls the vehicle behavior control device according to the play information.

2. The vehicle control device according to claim 1,
wherein the acquirer acquires information indicating the state of charge of a power supply device feeding power to the vehicle behavior control device,
wherein the controller controls the vehicle behavior control device in either the limited game mode or the normal game mode based on the acquired information indicating the state of charge.

3. The vehicle control device according to claim 2,
wherein the controller sets the amount of power that can be consumed in the limited game mode based on the charging rate of the power supply device.

4. The vehicle control device according to claim 1,
wherein the acquirer acquires input information entered by the occupant indicating that the game is to be performed in the limited game mode, and
wherein the controller controls the vehicle behavior control device in either the limited game mode or the normal game mode based on the acquired input information.

5. A vehicle control method in which step is performed by a vehicle control device mounted on a vehicle, the vehicle control method comprising:
acquiring play information of a game played by an occupant of the vehicle; and
controlling a vehicle behavior control device capable of oscillating a vehicle body according to the acquired play information;
wherein in the controlling, when controlling the vehicle behavior control device according to the play information, the vehicle behavior control device is controlled in either a limited game mode, which limits the amount of power that can be consumed for driving the vehicle behavior control device, or a normal game mode, which has a larger amount of power consumption than the limited game mode.
